(19) United States
(12) Patent Application Publication
(10) Pub. No.: US 2003/0047271 A1
(43) Pub. Date: Mar. 13, 2003

(54) Microembossed thin microporous films having improved impact strength and high moisture vapor transmission rates (MVTRs)

(76) Inventors: Pai-Chuan Wu, Cincinnati, OH (US); Leopoldo V. Cancio, Cincinnati, OH (US)

Correspondence Address: David J Josephic, Wood Herron & Evans LLP, 2700 Carew Tower, 441 Vine Street, Cincinnati, OH, 45202-2917, US

(21) Appl. No.: 09/548,403

(22) Filed: Apr. 13, 2000

Related U.S. Application Data
(63) Continuation-in-part of application No. 09/480,374, filed on Jan. 10, 2000.
Application No. 09/480,374 is a continuation-in-part of application No. 09/080,063, filed on May 15, 1998, now Pat. No. 6,013,151.
Application No. 09/080,063 is a continuation-in-part of application No. 09/395,627, filed on Sep. 14, 1999.

(51) Int. Cl. B32B 31/00

(52) U.S. Cl. 156/229; 156/308.2; 156/244.27; 156/324; 264/288.4; 264/414

(57) ABSTRACT

Microembossed film products permeable to moisture vapor and which act as barriers to liquid are made by a high speed method. The microembossed microporous films have impact strengths greater than 150 grams according to ASTM D-1709 and high moisture vapor transmission rates (MVTRs) on the order of about 1000 to about 4500 gms/m²/day according to ASTM E96E.

### RELATED APPLICATIONS

This application is a continuation-in-part application of application Ser. No. 09/480,374, filed Jan. 10, 2000, which is, in turn, a continuation-in-part application of application Ser. No. 09/080,063, filed May 15, 1998, now U.S. Pat. No. 6,013,151, and, application Ser. No. 09/395,627, filed on Sep. 14, 1999. All of the above applications are incorporated herein in their entireties by reference.

### FIELD OF THE INVENTION

This invention relates to thin microporous films having improved impact strength and high MVTRs.

### BACKGROUND OF THE INVENTION

Methods of making plastic film date back many years. For example, more than thirty years ago U.S. Pat. No. 3,484,835 (1968) issued to Trounstine, et al., and it is directed to embossed plastic film having desirable handling characteristics and fabricating useful articles such as diapers. Since that time, many patents have issued in the field.

U.S. Pat. No. 4,376,147 (1983) discloses an embossed cross direction (CD) and machine direction (MD) film. U.S. Pat. Nos. 5,202,173 (1993) and 5,296,184 (1994) teach an ultra-soft thermoplastic film which was made by incrementally stretching the embossed film and the formation of perforations to achieve breathability. The film may include fillers. Polymer films of polycaprolactone (PCL) and starch polymer or polyvinyl alcohol (PVOH) upon incremental stretching also produce breathable products, as disclosed in U.S. Pat. Nos. 5,200,247 and 5,407,979. More recently, U.S. Pat. No. 5,865,926 issued for a method of making a cloth-like microporous laminate of a nonwoven fibrous web and thermoplastic film having air and moisture vapor permeabilities with liquid-barrier properties.

Methods of making microporous film products have also been known for some time. For example, U.S. Pat. No. 3,832,267, to Liu, teaches the melt-embossing of a polyolefin film containing a dispersed amorphous polymer phase prior to stretching or orientation to improve gas and moisture vapor transmission of the film. According to the Liu '267 patent, a film of crystalline polypropylene having a dispersed amorphous polypropylene phase is first embossed prior to biaxially drawing (stretching) to produce an oriented imperforate film having greater permeability. The dispersed amorphous phase serves to provide microvoids to enhance the permeability of the otherwise imperforate film to improve moisture vapor transmission (MVT). The embossed film is preferably embossed with at least about 4 and not more than about 600 bosses per square inch and drawn sequentially. The 4 to 600 bosses per square inch is equivalent to about 2 to 25 embossed lines per inch.

In 1976, Schwarz published a paper which described polymer blends and compositions to produce microporous substrates (Eckhard C. A. Schwartz (Biax-Fiberfilm), “New Fibrillated Film Structures, Manufacture and Uses”, Pap. Synth. Conf. (TAPPI), 1976, pages 33-39). According to this paper, a film of two or more incompatible polymers, where one polymer forms a continuous phase and a second polymer forms a discontinuous phase, upon being stretched will phase separate, thereby leading to voids in the polymer matrix and increasing the porosity of the film. The continuous film matrix of a crystallizable polymer may also be filled with inorganic filler such as clay, titanium dioxide, calcium carbonate, etc., to provide microporosity in the stretched polymeric substrate.

Many other patents and publications disclose the phenomenon of making microporous thermoplastic film products. For example, European patent 141592 discloses the use of a polyolefin, particularly ethylene vinyl acetate (EVA) containing a dispersed polystyrene phase which, when stretched, produces a voided film which improves the moisture vapor permeability of the film. This EP '592 patent also discloses the sequential steps of embossing the EVA film with thick and thin areas followed by stretching to first provide a film having voids which, when further stretched, produces a net-like product. U.S. Pat. Nos. 4,452,845 and 4,596,738 also disclose stretched thermoplastic films where the dispersed phase may be a polyethylene filled with calcium carbonate to provide the microvoids upon stretching. U.S. Pat. Nos. 3,137,746; 4,777,073; 4,814,124; and 4,921,653 disclose the same processes described by the above-mentioned publications involving the steps of first embossing a polyolefin film containing a filler and then stretching that film to provide a microporous product. In the case of the '746 patent, the embossing is up to 300 bosses per square inch which is equivalent to about 17 embossed lines per inch. The '073 patent does not teach the geometry of the embossing. The '124 and '653 patents teach embossing to improve tear strength.

Notwithstanding the extensive development of the art for making plastic films and breathable microporous films to provide air and moisture vapor permeabilities with liquid-barrier properties, further improvements are needed. In particular, improvements are desired for producing microporous film products having improved impact strength and other desirable properties.

### SUMMARY OF THE INVENTION

This invention is directed to a microembossed microporous thermoplastic film having improved impact strength and high MVTRs. The product can be made on high-speed production machinery at speeds of at least about 550 fpm, preferably about 700-1200 fpm.

In the above-identified patent application Ser. No. 09/080,063, incrementally stretched microembossed thin films were disclosed having high MVTRs, i.e., greater than 1000 gms/m²/day, preferably about 2000 to 4500 gms/m²/day (ASTM E96E). This invention is directed to further improvements of incrementally stretched mircoembossed thin films having high MVTRs and high impact strength. Breathable strip or patch laminates of nonwoven webs with the microporous film are also produced at high speeds according to this invention.

It has been found that an incrementally stretched microporous thin thermoplastic film having a microembossed rectangular engraving of intersecting cross direction (CD) and machine direction (MD) lines of about 165 to 300 lines per inch in both directions provides a higher impact strength than a non-embossed film. Impact strengths greater than about 150 grams are achieved (ASTM D1709). The thin film has a thickness of about 0.0008 to about 0.002 inch and an engraving depth of about 0.0008 to about 0.002 inch. In a preferred rectangular embossed film, about 250 lines per inch are embossed at a depth of about 0.001 to 0.0015 inch in both the width (CD) and length (MD) of the film with a film thickness of about 0.001 to 0.002 inch.

Strip or patch laminates of nonwoven webs and the incrementally stretched microembossed film are also provided where only a portion of the film is laminated to the nonwoven web. In the case of these laminates, the film-only portion is provided with improved impact strength and the resulting laminate has an overall improved impact and tear strength.

The method of this invention involves extrusion of a microporous-formable thermoplastic film into a CD and MD embossing roller nip where the roller is engraved with a rectangular pattern of CD and MD lines of about 165-300 per inch in both directions. The microporous-formable thermoplastic composition of the film may comprise a blend of a thermoplastic polymer and a mechanical pore-forming agent such as an inorganic filler (CaCO₃). The pore-forming agent in the film is then activated upon incremental stretching to form a microporous film. This unique method not only provides economies in manufacturing breathable laminates, but also enables their production on high-speed machinery on the order of about 700-1200 fpm.

The method involves melting a microporous-formable thermoplastic composition and slot-die extruding a web of that composition through a cooling zone into a nip of embossing rollers to form a film at a speed preferably greater than about 700 feet per minute (fpm). A stream of cooling gas (air) is directed at the film during its drawdown into a film. The air flow through the cooling zone is substantially parallel to the surface of the web to cool the web and form a film without draw resonance.

In the preferred form of the method, the effectiveness of the cooling gas is enhanced by creating a plurality of vortices of the gas as the stream moves through the zone to cool the web. The vortices enhance the effectiveness of the cooling gas by mixing the cooling gas and making the flow of the cooling gas turbulent in the cooling zone. A cooling device is used to create the vortices and make the gas stream move in different directions parallel to the movement of the web.

Alternatively, the gas stream moves primarily in the same direction as the web movement or in a direction opposite to the movement of the web. Alternatively, where it is desired to achieve impact strength of the microporous film in a strip laminate with a nonwoven, a strip of nonwoven fibrous web is introduced into the nip of embossing rollers with the extruded film and the lamination temperature is controlled by the cooling gas to control target bond levels at high speeds of extrusion lamination. For example, target bond levels between the plastic film and the nonwoven web are achieved at speeds in excess of about 700 fpm even up to about 1200 fpm, or more. Target bond levels of, for example, 100 gms/cm (about 250 grams/inch) between the film and nonwoven are achieved at line speeds on the order of 900 fpm for commercial purposes. The compressive force between the web and the film at the nip is controlled to bond the surface of the web to form a laminated sheet. Furthermore, even at high line speeds the film gauge is controlled without draw resonance. For example, a fixed film basis weight of about grams per square meter (gsm) is achieved at 900 fpm. Thus, the method of cooling eliminates draw resonance which otherwise may normally be encountered under such conditions.

According to the invention, breathable microembossed films and laminates which are permeable to air and water vapor, but are a barrier to liquid, are produced. These breathable products are made from a microporous-formable thermoplastic composition comprising a thermoplastic polymer and filler particles. Upon slot-die extrusion and microembossing of such composition, followed by applying a stretching force to the film at high speeds along lines substantially and uniformly across the film and throughout its depth, a microembossed microporous film having improved impact strength is formed. Strip and patch breathable laminates are made when a nonwoven fibrous web is laminated to a portion of the microembossed film during the extrusion. The effectiveness of the cooling gas is enhanced by creating a plurality of vortices of the gas as the stream moves through the cooling zone to cool the web during extrusion lamination. Thereafter, preferably an incremental stretching force is applied to the microembossed film or the laminate at high speeds substantially and uniformly across the film and throughout its depth to provide a microporous laminate of film and nonwoven. Tentering may also be used to stretch the laminate.

Other benefits, advantages and objectives of this invention will be further understood with reference to the following detailed description.

### DETAILED DESCRIPTION OF THE INVENTION

It is a primary objective of this invention to produce microembossed thin microporous films having improved impact strength on high-speed production machinery. It is the further objective of the method to produce breathable strip and patch laminated products of regular gauge without draw resonance. It is another objective to produce such laminates having satisfactory bond strengths while maintaining the appearance of a fabric or cloth having suitable moisture vapor transmission rates and air permeability while maintaining liquid-barrier properties.

The high speed method of making either a microembossed film or a strip (patch) laminate of a nonwoven fibrous web with the film comprises melt blending a thermoplastic polymer and filler particles to form a thermoplastic polymer composition. A web of the molten thermoplastic composition is extruded from a slot die through a cooling zone into a nip of rollers to form a film at a speed preferably greater than about 700 fpm, and introducing strips of a nonwoven fibrous web into said nip of rollers and controlling the temperature and compressive force between the web and the film at the nip to bond the surfaces of the web strips to the film and to form a laminated sheet having a bond strength between the film and the web of about 100 to about 600 grams/inch when measured at about room temperature. Preferably, bond strengths are about 200 grams/inch to about 500 grams/inch to facilitate incremental stretching at about 700-1200 fpm to provide a microporous laminate. The incremental stretching force is applied across the laminated sheet to provide a cloth-like microporous laminate having a web to film bond strength of about 100 to about 200 grams/inch.

In a preferred mode, the high speed method of making a microembossed microporous thermoplastic film involves melt blending a composition comprising

(a) about 30% to about 45% by weight of a linear low density polyethylene (LLDPE),

(b) about 1% to about 10% by weight of a low density polyethylene (LDPE), and

(c) about 40% to about 60% by weight calcium carbonate filler particles of about 0.1 to 1 micron.

The melt-blended composition is slot-die extruded as a web through a cooling zone into a nip of a metal engraved embossing roller and rubber roller. The embossing roller has a rectangular engraved pattern of about 165 to 300, preferably about 250, lines per inch to provide a CD and MD embossed film of 250 lines per inch in both directions. The film thickness is generally about 0.0008 to 0.002 inch with an embossed depth of about 0.0008 to 0.002 inch. Most preferably, the film thickness is about 0.001 to 0.002 inch with the 250 lines per inch rectangular embossed pattern and an embossed depth of about 0.001 to 0.0015 inch. Upon incrementally stretching this microembossed film, a microporous film is produced having an unexpectedly higher impact strength when compared to a non-embossed film. The embossed film is made at speeds on the order of about 550 to about 1200 fpm without draw resonance. A device for directing a stream of cooling gas to flow in the cooling zone substantially parallel to the web surface is shown, for example, in U.S. Pat. Nos. 4,718,178 and 4,779,355. The entire disclosure of these patents is incorporated herein by reference as examples of devices which may be employed to provide enhanced effectiveness of the cooling gas by creating a plurality of vortices of the gas as the stream moves through the cooling zone to cool the web. Thereafter, an incremental stretching force is applied to the microembossed film at high speeds along lines substantially and uniformly across the film and throughout its depth to provide a microembossed microporous film.

The blend of LLDPE and LDPE within the above approximate ranges of components enables the production of microporous film at high speed when balanced with the prescribed amount of calcium carbonate. In particular, the LLDPE is present in an amount of about 30% to about 45% by weight in order to provide a sufficient amount of matrix to carry the calcium carbonate filler particles thereby enabling the film to be handled and stretched without pin holing and breakage. The LDPE in an amount of about 1% to about 10% by weight also contributes to the production of film without pin holing and enables the high speed production without draw resonance. The polymeric matrix is balanced with an amount of about 40% to about 60% by weight of calcium carbonate particles having an average particle diameter of preferably about 1 micron to achieve a sufficient moisture vapor transmission rate (MVTR) in the range of about 1000 gms/m²/day to 4500 gms/m²/day as measured by using the ASTM E96E method. Furthermore, the melt-blended composition may include a triblock polymer in an amount of about 0% to about 6% by weight to facilitate stretching in high-speed production without breakage. Other components such as about 5% by weight high density polyethylene (HDPE) and about 1% by weight antioxidants/processing aids are used. An incremental stretching force may be applied in line to the formed film under ambient conditions or at an elevated temperature at speeds greater than about 700 fpm along lines substantially uniformly across the film and throughout it depth to provide a microporous film.

The method of this invention also involves lamination of the microporous-formable thermoplastic film to a strip or patch of nonwoven fibrous web during extrusion. The extrusion lamination is conducted at the same high speeds where a nonwoven fibrous web is introduced into the embossing nip of rollers along with the microporous-formable thermoplastic extrudate. The compressive force between the fibrous web and the extrudate is controlled to bond one surface of the web to the film and form a strip or patch laminate. The laminate is then incrementally stretched along lines substantially uniformly across the laminate and throughout its depth in one direction to render the microembossed film microporous. The laminate may be stretched in both the cross direction and the machine direction to provide breathable cloth-like liquid barriers capable of transmitting moisture vapor and air.

A. Materials for the Method

The thermoplastic polymer for the film preferably is of the polyolefin type and may be any of the class of thermoplastic polyolefin polymers or copolymers that are processable into a film or for direct lamination by melt extrusion onto the fibrous web. A number of thermoplastic copolymers suitable in the practice of the invention are of the normally-solid oxyalkanoyl polymers or dialkanoyl polymers represented by poly(caprolactone) blended with polyvinylalcohol or starch polymers that may be film-formed. The olefin based polymers include the most common ethylene or propylene based polymers such as polyethylene, polypropylene, and copolymers such as ethylene vinylacetate (EVA), ethylene methyl acrylate (EMA) and ethylene acrylic acid (EAA), or blends of such polyolefins. Other examples of polymers suitable for use as films include elastomeric polymers. Suitable elastomeric polymers may also be biodegradable or environmentally degradable. Suitable elastomeric polymers for the film include poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), poly(ethylene butylacrylate), polyurethane, poly(ethylene-propylene-diene), ethylene-propylene rubber. This new class of rubber-like polymers may also be employed and they are generally referred to herein as metallocene polymers or polyolefins produced from single-cite catalysts. The most preferred catalysts are known in the art as metallocene catalysts whereby ethylene, propylene, styrene and other olefins may be polymerized with butene, hexene, octene, etc., to provide elastomers suitable for use in accordance with the principles of this invention, such as poly(ethylene-butene), poly(ethylene-hexene), poly(ethylene-octene), poly(ethylene-propylene), and/or polyolefin terpolymers thereof.

The microporous-formable film composition can be achieved by formulating a thermoplastic polymer with suitable additives and pore-forming fillers to provide an extrudate or film for embossing and lamination with the nonwoven web. Calcium carbonate and barium sulfate particles are the most common fillers. Microporous-formable compositions of polyolefins, inorganic or organic pore-forming fillers and other additives to make microporous sheet materials are known. This method may be done in line and provides economies in manufacturing and/or materials over known methods of making laminates. In addition, as developed above, microporous-formable polymer compositions may be obtained from blends of polymers such as a blend of an alkanoyl polymer and polyvinyl alcohol as described in U.S. Pat. No. 5,200,247. In addition, blends of an alkanoyl polymer, destructured starch and an ethylene copolymer may be used as the microporous-formable polymer composition as described in U.S. Pat. No. 5,407,979. With these polymer blends, it is unnecessary to use pore-forming fillers to provide microporosity upon incremental stretching. Rather, the different polymer phases in the film themselves, when the film is stretched at ambient or room temperature, produce microvoids.

The nonwoven fibrous web may comprise fibers of polyethylene, polypropylene, polyesters, rayon, cellulose, nylon, and blends of such fibers. A number of definitions have been proposed for nonwoven fibrous webs. The fibers are usually staple fibers or continuous filaments. As used herein “nonwoven fibrous web” is used in its generic sense to define a generally planar structure that is relatively flat, flexible and porous, and is composed of staple fibers or continuous filaments. For a detailed description of nonwovens, see “Nonwoven Fabric Primer and Reference Sampler” by E. A. Vaughn, Association of the Nonwoven Fabrics Industry, 3d Edition (1992).

In a preferred form, the microembossed microporous film has a gauge or a thickness between about 0.0008 and 0.002 inch and, most preferably about 0.001 inch. The nonwoven fibrous webs of the strip or patch laminated sheet normally have a weight of about 5 grams per square yard to 75 grams per square yard preferably about 20 to about 40 grams per square yard. The composite or laminate can be incrementally stretched in the cross direction (CD) to form a CD stretched composite. Furthermore, CD stretching may be followed by or preceded by stretching in the machine direction (MD) to form a composite which is stretched in both CD and MD directions. As indicated above, the microembossed microporous films or laminates may be used in many different applications such as baby diapers, baby training pants, catamenial pads and garments, and the like where moisture vapor and air transmission properties, as well as fluid barrier properties, are needed.

B. Stretchers for the Microporous-Formable Laminates

A number of different stretchers and techniques may be employed to stretch the starting or original laminate of a nonwoven fibrous web and microporous-formable film. These laminates of nonwoven carded fibrous webs of staple fibers or nonwoven spun-bonded fibrous webs may be stretched with the stretchers and techniques described as follows:

1. Diagonal Intermeshing Stretcher

The diagonal intermeshing stretcher consists of a pair of left hand and right hand helical gear-like elements on parallel shafts. The shafts are disposed between two machine side plates, the lower shaft being located in fixed bearings and the upper shaft being located in bearings in vertically slidable members. The slidable members are adjustable in the vertical direction by wedge shaped elements operable by adjusting screws. Screwing the wedges out or in will move the vertically slidable member respectively down or up to further engage or disengage the gear-like teeth of the upper intermeshing roll with the lower intermeshing roll. Micrometers mounted to the side frames are operable to indicate the depth of engagement of the teeth of the intermeshing roll.

Air cylinders are employed to hold the slidable members in their lower engaged position firmly against the adjusting wedges to oppose the upward force exerted by the material being stretched. These cylinders may also be retracted to disengage the upper and lower intermeshing rolls from each other for purposes of threading material through the intermeshing equipment or in conjunction with a safety circuit which would open all the machine nip points when activated.

A drive means is typically utilized to drive the stationery intermeshing roll. If the upper intermeshing roll is to be disengageable for purposes of machine threading or safety, it is preferable to use an antibacklash gearing arrangement between the upper and lower intermeshing rolls to assure that upon reengagement the teeth of one intermeshing roll always fall between the teeth of the other intermeshing roll and potentially damaging physical contact between addenda of intermeshing teeth is avoided. If the intermeshing rolls are to remain in constant engagement, the upper intermeshing roll typically need not be driven. Drive may be accomplished by the driven intermeshing roll through the material being stretched.

The intermeshing rolls closely resemble fine pitch helical gears. In the preferred embodiment, the rolls have 5.935″ diameter, 45° helix angle, a 0.100″ normal pitch, 30 diametral pitch, 14½° pressure angle, and are basically a long addendum topped gear. This produces a narrow, deep tooth profile which allows up to about 0.090″ of intermeshing engagement and about 0.005″ clearance on the sides of the tooth for material thickness. The teeth are not designed to transmit rotational torque and do not contact metal-to-metal in normal intermeshing stretching operation.

2. Cross Direction Intermeshing Stretcher

The CD intermeshing stretching equipment is identical to the diagonal intermeshing stretcher with differences in the design of the intermeshing rolls and other minor areas noted below. Since the CD intermeshing elements are capable of large engagement depths, it is important that the equipment incorporate a means of causing the shafts of the two intermeshing rolls to remain parallel when the top shaft is raising or lowering. This is necessary to assure that the teeth of one intermeshing roll always fall between the teeth of the other intermeshing roll and potentially damaging physical contact between intermeshing teeth is avoided. This parallel motion is assured by a rack and gear arrangement wherein a stationary gear rack is attached to each side frame in juxtaposition to the vertically slidable members. A shaft traverses the side frames and operates in a bearing in each of the vertically slidable members. A gear resides on each end of this shaft and operates in engagement with the racks to produce the desired parallel motion.

The drive for the CD intermeshing stretcher must operate both upper and lower intermeshing rolls except in the case of intermeshing stretching of materials with a relatively high coefficient of friction. The drive need not be antibacklash, however, because a small amount of machine direction misalignment or drive slippage will cause no problem. The reason for this will become evident with a description of the CD intermeshing elements.

The CD intermeshing elements are machined from solid material but can best be described as an alternating stack of two different diameter disks. In the preferred embodiment, the intermeshing disks would be 6″ in diameter, 0.031″ thick, and have a full radius on their edge. The spacer disks separating the intermeshing disks would be 5½″ in diameter and 0.069″ in thickness. Two rolls of this configuration would be able to be intermeshed up to 0.231″ leaving 0.019″ clearance for material on all sides. As with the diagonal intermeshing stretcher, this CD intermeshing element configuration would have a 0.100″ pitch.

3. Machine Direction Intermeshing Stretcher

The MD intermeshing stretching equipment is identical to the diagonal intermeshing stretch except for the design of the intermeshing rolls. The MD intermeshing rolls closely resemble fine pitch spur gears.

In the preferred embodiment, the rolls have a 5.933″ diameter, 0.100″ pitch, 30 diametral pitch, 14½° pressure angle, and are basically a long addendum, topped gear. A second pass was taken on these rolls with the gear hob offset 0.010″ to provide a narrowed tooth with more clearance. With about 0.090″ of engagement, this configuration will have about 0.010″ clearance on the sides for material thickness.

4. Incremental Stretching Technique

The above described diagonal, CD or MD intermeshing stretchers may be employed to produce the incrementally stretched laminate of nonwoven fibrous web and microporous-formable film to form the microporous laminate of this invention. The stretching operation is usually employed on an extrusion laminate of a nonwoven fibrous web of staple fibers or spun-bonded filaments and microporous-formable thermoplastic film. In one of the unique aspects of this invention a laminate of a nonwoven fibrous web of spun-bonded filaments may be incrementally stretched to provide a very soft fibrous finish to the laminate that looks like cloth. The laminate of nonwoven fibrous web and microporous-formable film is incrementally stretched using, for instance, the CD and/or MD intermeshing stretcher with one pass through the stretcher with a depth of roller engagement at about 0.025 inch to 0.120 inch at speeds from about 700 fpm to 1200 fpm or faster. The results of such incremental or intermesh stretching produces laminates that have excellent breathability and liquid-barrier properties, yet provide superior bond strengths and soft cloth-like textures.

The following example illustrates the method of making laminates of this invention. In light of these examples and this further detailed description, it is apparent to a person of ordinary skill in the art that variations thereof may be made without departing from the scope of this invention.

### BRIEF DESCRIPTION OF THE DRAWINGS

The invention is further understood with reference to the drawings in which:

FIG. 1 is a schematic of an inline extrusion lamination and incremental stretching apparatus for making the microporous laminate of this invention.

FIG. 2 is a cross sectional view taken along the line 2-2 of FIG. 1 illustrating the intermeshing rollers in diagrammatic form.

FIG. 3 is a graph demonstrating the line speeds for Examples 1-5.

FIG. 4 is a graph demonstrating the moisture vapor transmission properties of both microembossed and flat microporous films.

FIG. 5 is a graph demonstrating the moisture vapor transmission rate can be adjusted by heating the precursor film.

FIG. 6 is a graph demonstrating the impact strengths of the microembossed and flat films which have been incrementally stretched.

FIG. 7 is a graph demonstrating the tear strength of the microembossed and flat films which have been incrementally stretched.

### EXAMPLES 1-5

Blends of LLDPE and LDPE having the compositions reported in the following TABLE 1 were extruded to form both flat (non-embossed) and microembossed films and the films were then incrementally stretched to provide microporous films.

The microembossed film was made with a metal embossing roller having a rectangular engraving of CD and MD lines with about 250 lines per inch, with engraving depth to about 0.0012 inch. This generally rectangular pattern is disclosed, for example, in U.S. Pat. No. 4,376,147 which is incorporated herein by reference, although the 250 lines per inch and depth of 0.0012 inch are not disclosed. This microembossed pattern provides a matte finish to the film but is undetectable to the naked eye. The flat film was made with a flat chrome roller.

TABLE 1

| Formulation (by wt.) | 1 | 2 | 3 | 4 | 5 |
|---|---|---|---|---|---|
| CaCO₃ | 44.2 | 44.2 | 44.2 | 44.2 | 44.2 |
| LLDPE | 44.1 | 44.9 | 41.9 | 41.9 | 41.9 |
| LDPE | 1.5 | 3.7 | 3.7 | 3.7 | 3.7 |
| Others* | 10.2 | 10.2 | 10.2 | 10.2 | 10.2 |
| Screw RPM | | | | | |
| A | 33 | 45 | 57 | 64 | 75 |
| B | 33 | 45 | 57 | 64 | 75 |
| Basis wt. (gms/m²) | 45 | 45 | 45 | 45 | 45 |
| Gauge (mils) | 2 | 2 | 2 | 2 | 2 |
| Line Speed (fpm) | 550 | 700 | 900 | 1000 | 1200 |
| Air Knife (cfm/inch) | 5-25 | 5-25 | 5-25 | 5-25 | 5-25 |

| | | |
|---|---|---|
| Web Stability | Poor | Good web stability without draw |
| | gauge | resonance |
| | control | |
| | with draw | |
| | resonance | |

*Other components include 2.5% by weight of a styrene-butadiene-styrene (SBS) triblock polymer, Shell Kraton 2122X, which is an SBS <50% by wt. + mineral oil <30% by wt., EVA copolymer <15% by wt., polystyrene <10% by wt., hydrocarbon resin <10% by wt., antioxidant/stabilizer <1% by wt., and hydrated amorphous silica <1% by wt.

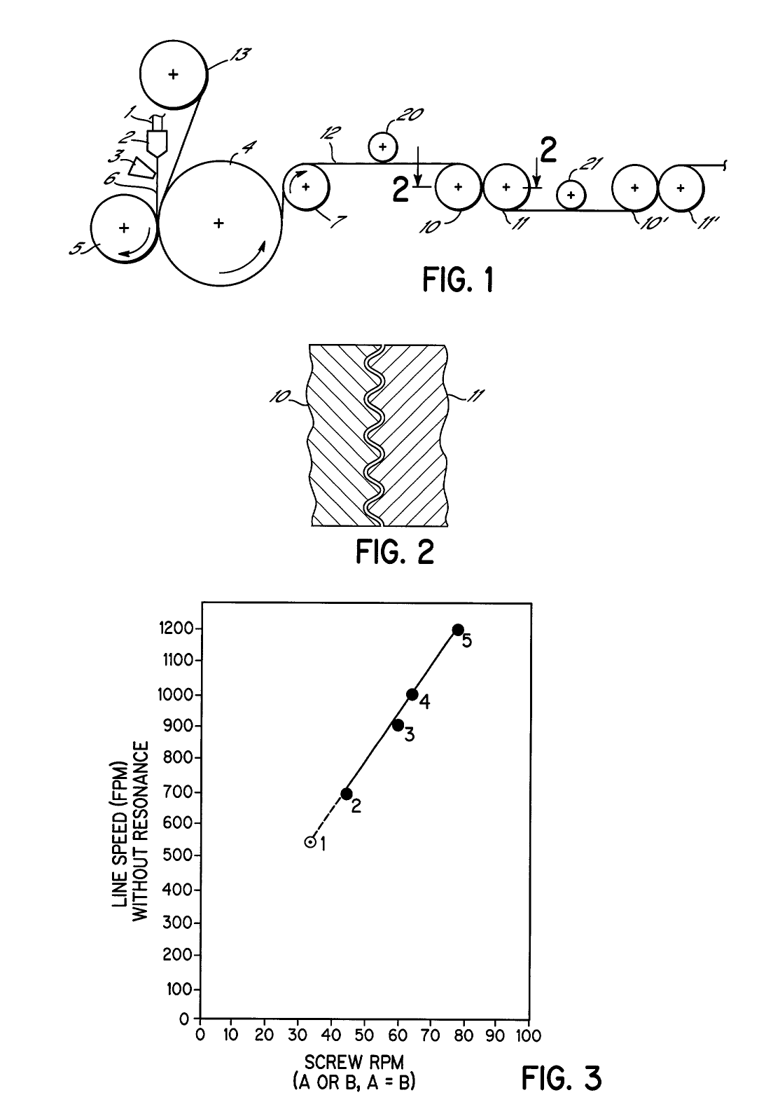

Each of the formulations of 1-5 were extruded into films employing an extrusion apparatus as shown diagrammatically in FIG. 1. As shown, the apparatus may be employed for film extrusion with and without lamination. In the case of film extrusion, the formulations of Examples 1-5 were fed from an extruder 1 through slot die 2 to form the extrudate 6 into the nip of a rubber roll 5 and a metal roll 4 with an air knife 3. A microembossed metal roll and a flat chrome roll were each used to make the microembossed and flat films, respectively, for comparison. Where extrusion lamination is practiced, there is an incoming web strip of fibrous material 9 from roller 13 which is also introduced into the nip of the rubber roll 5 and metal roll 4. In Examples 1-5, the thermoplastic film was produced for subsequent incremental stretching to form both the microembossed and non-embossed microporous films. As shown in TABLE 1, over speeds of about 550 fpm to 1200 fpm, a polyethylene film 6 on the order of about 2 mils in thickness was made which is taken off at roller 7. The air knife 3 has a length of about 120″ and an opening of about 0.035″-0.060″ and air is blown through the opening and against the extrudate 6 at about 5 cfm/inch to 25 cfm/inch. The compressive force at the nip and the air knife are controlled such that the film is made without pin holing and without draw resonance in the case of Examples 2-5. Where the LDPE was included in the composition at a level of 1.5% by weight, draw resonance was encountered at a line speed of 550 fpm. However, when the LDPE was included in the formulation at a level of 3.7% by weight with the LLDPE at a level of 44.1-44.9% by weight, film production was able to be achieved at high speeds greater than 550 fpm up to 1200 fpm without draw resonance. The melt temperatures from the feed zone to the screw tip of extruders A and B were maintained at about 400-430° F. with die temperatures of approximately 450° F. to extrude the precursor film around 2 mils (45 gms/m²).

FIG. 3 is a graph demonstrating the line speeds for Examples 1-5. Example 1, which contained only 1.5% by weight of LDPE, resulted in a poor film gauge control with draw resonance even with the air knife 3. However, when the LDPE was increased to about 3.7% by weight, excellent web stability was achieved without draw resonance even when line speeds were increased to about 1200 fpm. This is shown diagrammatically in FIG. 3.

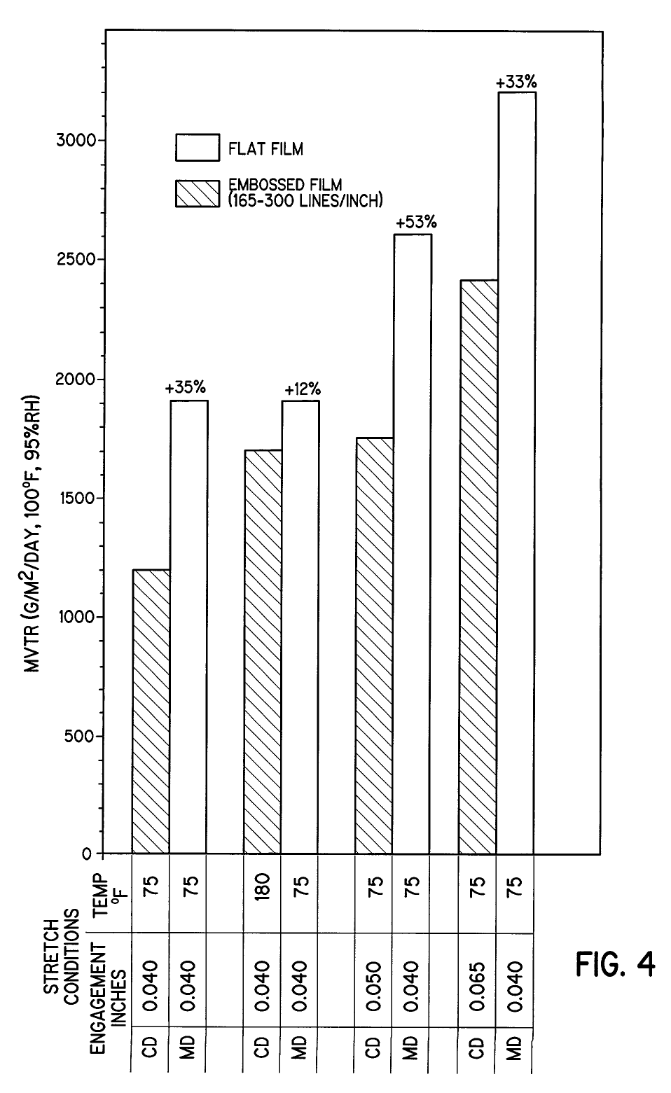

FIG. 4 is a graph demonstrating the moisture vapor transmission properties of both microembossed and flat films resulting from incrementally stretching the precursor films of Examples 2-5 under different temperatures and stretch roller engagement conditions. As shown schematically in FIG. 1, where the incoming film 12 at ambient temperature was passed through temperature controlled rollers 20 and 21 before CD and MD incremental stretching rollers (10 and 11, and 10′ and 11′), the temperatures and the depths of engagements can be controlled.

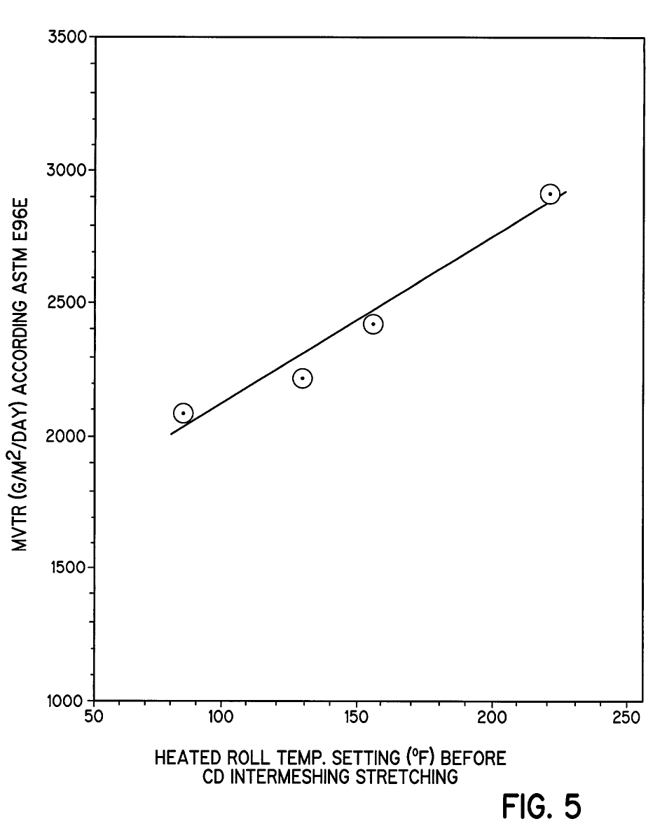

Remarkably, the MVTR of the flat film exceeded the MVTR of the embossed film as shown in FIG. 4. In brief, MVTRs for the embossed film on the order of about 1200-2400 gms/m²/day were achieved, whereas MVTRs for the flat film on the order of about 1900-3200 gms/m²/day were achieved. Unexpectedly, as also shown in FIG. 5, the MVTR of the microporous film can also be controlled by the web temperature during the stretching. FIG. 5 shows the film when heated to different temperatures before CD stretching can result in different MVTRs. The data reported in FIG. 5 was for a CD rollers engagement dept of 0.065″ and MD rollers engagement depth of 0.040″ where the temperature of roller 21 was maintained at ambient. As stated above, the embossed film was made with a metal embossing roller having a rectangular engraving of CD and MD lines with about 250 lines per inch which is within the range of 165-300 lines per inch. The general pattern is disclosed, for example, in U.S. Pat. No. 4,376,147 which is incorporated herein by reference. This micro pattern provides a matte finish to the film but is undetectable to the naked eye.

### EXAMPLE 6

Other blends of LLDPE, LDPE and HDPE having the compositions reported in the following TABLE 2 were extruded to form flat films and the films were then incrementally stretched to provide microporous films having high MVTRs greater than about 2000 gms/m²/day, for example from about 2000 to 4500 gms/m²/day.

TABLE 2

| Formulation (by wt.): | |
|---|---|
| CaCO₃ | 45 |
| LLDPE | 41 |
| LDPE | 5 |
| HDPE | 5 |
| TiO₂ | 3 |
| Antioxidant/processing aid | 1 |

| | |
|---|---|
| Basis Weight (gms/m²) | 40 |
| Gauge (mils) | 1.2 |
| Line Speed (fpm) | 900 |
| ACD No. 1 (cfm/foot) | 68 |
| ACD No. 2 (cfm/foot) | 113 |
| Web Stability | Good, without |
| | draw resonance |

The formulation of TABLE 2 was extruded into films employing an extrusion apparatus similar to that as shown diagrammatically in FIG. 1. As shown, the apparatus may be employed for film extrusion with and without lamination. In the case of film extrusion, the formulation of EXAMPLE 6 is fed from an extruder 1 through slot die 2 to form the extrudate 6 into the nip of a rubber roll 5 and a metal roll 4. The metal roll is a polished chrome roll. Instead of the air knife, two air cooling devices (ACD), ACD No. 1 and ACD No. 2 are used, but they are not shown on the drawing. Again, where extrusion lamination is practiced, there is an incoming web of fibrous material 9 from roller 13 which is also introduced into the nip of the rubber roll 5 and metal roll 4. In EXAMPLE 6, the thermoplastic film is produced for subsequent incremental stretching to form the microporous film. As shown in TABLE 2, a polyethylene film 6 on the order of about 1.2 mils in thickness is made at a speed of about 900 fpm, which is taken off at roller 7. The ACDs have dimensions approximating the web width with a sufficient manifold sized to deliver the cooling air. As stated above, these ACDs are described in more detail in the above mentioned U.S. Pat. Nos. 4,718,178 and 4,779,355. The air velocity blown through the nozzle of ACD No. 1 and against the extrudate 6 is about 4000 fpm at the exit of the nozzle, and air volume is 68 cfm per foot. The air velocity of ACD No. 2 is about 6800 fpm at the exit of the nozzle, and the air volume is 113 cfm per foot. The ACD No. 1 is located about 3.7 inches (95 mm) from the die and about 1 inch (25 mm) from the web 6. The ACD No. 2 is located on the opposite side of the web 6 about 11.2 inches (2.85 mm) from the die and about 0.6 inches (15 mm) from the web. The nip of the rubber roll 5 and metal roll 4 is located about 29 inches (736 mm) from the die. The compressive force at the nip and the ACDs are controlled such that the film is made without pin holing and without draw resonance.

The melt temperatures from the slot die feed zone to the screw tip of extruders A and B (not shown) were maintained to provide an extrudate temperature of about 243° C. with cooling gas from the ACDs No. 1 and No. 2 decreasing the web temperatures to 211° C.-181° C. before entering the nip. In this EXAMPLE 6, with reference to FIG. 1, where the incoming film 12 at ambient temperature is passed through temperature controlled rollers 20 and 21 before CD and MD incremental stretching rollers (10 and 11, and 10′ and 11′), the temperatures and the depths of engagements can be controlled. In brief, moisture vapor transmission rates (MVTRs) for the flat film on the order of about 2000-4500 gms/m²/day are achieved.

The MVTR of the microporous film can also be controlled by the web temperature during the stretching. When the film is heated to different temperatures before CD stretching, different MVTRs can result.

### EXAMPLES 7-16

Blends of LLDPE and LDPE having a composition of Example 2 described above were slot die extruded in accordance with the same procedures for Examples 1-5 to produce both flat (non-embossed) and microembossed films which were then incrementally stretched to provide microporous films. In the case of Examples 7-11, Example 7 was approximately 0.0015 inch film made for comparison with Examples 8-11 of the microembossed microporous film of this invention. The microembossed film had a rectangular pattern of 250 lines per inch in both the CD and MD with an engraved depth of about 0.001 inch to about 0.0015 inch and about 0.0015 inch in thickness. In the case of Examples 13-16, a flat chrome metal roller was used to produce the non-embossed microporous films of about 0.0015 inch in thickness, and Example 12 was made for comparison. The conditions of incremental stretching, resulting film basis weight, air cooling conditions, film impact strength and notched tear strength are all provided in the following Table 3.

TABLE 3

| EXAMPLE NO. | | 7 | 8 | 9 | 10 | 11 | 12 | 13 | 14 | 15 | 16 |
|---|---|---|---|---|---|---|---|---|---|---|---|
| Incremental stretching: | | | | | | | | | | | |
| CD engagement (inches) | | 0 | 0.040 | 0.040 | 0.050 | 0.065 | 0 | 0.040 | 0.040 | 0.050 | 0.065 |
| MD engagement (inches) | | 0 | 0.040 | 0.040 | 0.040 | 0.040 | 0 | 0.040 | 0.040 | 0.040 | 0.040 |
| Preheating | | | | | | | | | | | |
| CD ° F. | | | 75 | 180 | 75 | 75 | | 75 | 180 | 75 | 75 |
| MD ° F. | | | 75 | 75 | 75 | 75 | | 75 | 75 | 75 | 75 |
| Basis weight (gms/m²) | | 45.2 | 39.5 | 39.9 | 39.2 | 35.2 | 44.2 | 40.7 | 41.8 | 38.6 | 35.1 |
| MVTR ASTM E96E | | ≈0 | 1200 | 1700 | 1750 | 2400 | ≈0 | 1900 | 1900 | 2600 | 3200 |
| gm/cm²/day | | | | | | | | | | | |
| Air flow At ΔP = 90 psi | | ≈0 | 30 | 78 | 80 | 155 | ≈0 | 102 | 102 | 170 | 280 |
| cc/cm²/min | | | | | | | | | | | |
| Film Impact Strength | | 300 | 180 | 150 | 190 | 195 | 253 | 130 | 150 | 120 | 110 |
| ASTM D-1709 | | | | | | | | | | | |
| Grams | | | | | | | | | | | |
| Notch Elmendorf | | | | | | | | | | | |
| tear strength | | | | | | | | | | | |
| Grams | MD | 320 | 651 | 491 | 640 | 587 | 309 | 587 | 565 | 565 | 533 |
| ASTM D-1922 | CD | 693 | 885 | 1067 | 789 | 640 | 629 | 896 | 843 | 736 | 587 |

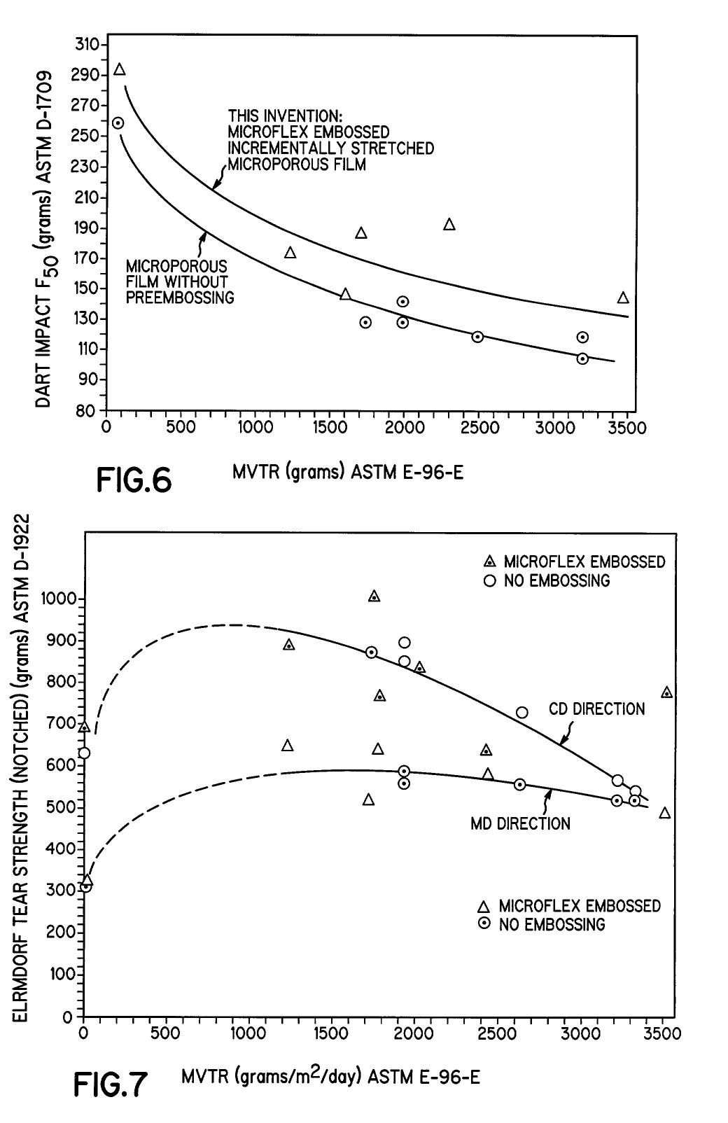

FIGS. 6 and 7 are graphs demonstrating the impact strengths of the microembossed and non-embossed microporous films which have been incrementally stretched in accordance with the procedures of Examples 8-11 and 13-16. With reference to Table 3, Examples 13-16, where the non-embossed films were incrementally stretched to produce micropores in the films, the microporous films lost their mechanical properties, such as elongation at break and impact strength. However, in contrast, Examples 8-11 demonstrate that the microembossed films of this invention upon incremental stretching to provide microporosities did not lose their impact strength to the same extent as the flat film. Thus, Table 3 and FIG. 6 demonstrate unexpectedly higher impact strengths for microembossed microporous film which has been incrementally stretched when compared to non-embossed film. Furthermore, the tear strengths of both the microembossed as well as the non-embossed film are comparable, as demonstrated by Table 3 and FIG. 7.

As reported in patent application Ser. No. 09/395,627, filed Sep. 14, 1999, it has been found that ACDs which provide a substantially parallel cooling air flow with vortices over the web surface efficiently cool the web. Surprisingly, web draw resonance which one may normally encounter in prior techniques has been eliminated or controlled at high speeds of about 500-1200 fpm of the web. Furthermore, as also reported in that application, when laminates of film and nonwoven are made, the bond strengths are very effectively achieved at targets which have not been possible with other known methods of cooling while at the same time maintaining film gauge controls, even at web high speeds.

In view of the above detailed description, it will be understood that variations will occur in employing the principles of this invention depending upon materials and conditions, as will be understood by those of ordinary skill in the art.

What is claimed is:

1. An incrementally stretched microembossed film having a high moisture vapor transmission rate (MVTR) comprising a thermoplastic polymer film containing a dispersed phase of particles selected from the group consisting of an inorganic filler and an organic material, said film having
(a) a microembossed rectangular pattern of about 165 to 300 embossed lines per inch across the width of the film which intersect with embossed lines of about 165 to 300 lines per inch across the length of the film said pattern having an embossed depth of about 0.0008 to about 0.002 inch,
(b) a film thickness of about 0.0008 to about 0.002 inch with incrementally stretched areas in the film to provide microporosity in the film with an MVTR greater than about 1000 gms/m²/day according to ASTM E96E, and
(c) a film impact strength of greater than about 150 grams according to ASTM D1709.

2. The film of claim 1 wherein the MVTR is on the order of about 2000 to about 4500 gms/m²/day according to ASTM E96E.

3. The film of claim 1 wherein the thermoplastic composition is a polymer selected from the group consisting of polyethylene, polypropylene, and copolymers thereof.

4. The film of claim 1 wherein said thermoplastic composition is an elastomeric polymer.

5. The film of claim 4 wherein said elastomeric polymer is selected from the group consisting of poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinyl acetate), poly(ethylene-methylacrylate), poly(ethylene-acrylic acid), polyethylene butylacrylate), polyurethane, poly(ethylene-propylene-diene), and ethylene-propylene rubber.

6. The film of claim 1 wherein said inorganic filler is selected from the group consisting of calcium carbonate and barium sulfate.

7. The film of claim 1 having a portion thereof laminated to a strip or patch of a fibrous web.

8. The film of claim 7 wherein the fibers of said fibrous web are selected from the group consisting of polypropylene, polyethylene, polyesters, cellulose, rayon, nylon, and blends or co-extrusions of two or more of such fibers.

9. The film of claim 7 wherein the fibrous web has a weight from about 5 to about 70 gms/yd².

10. The film of claim 1 wherein said film has a thickness on the order of about 0.001 to 0.002 inch and an embossed depth of about 0.001 to about 0.0015 inch and said pattern has about 250 lines per inch across each said width and length.

11. The film of claim 1 wherein the film composition comprises
(a) about 30% to about 45% by weight of a linear low density polyethylene,
(b) about 1% to about 10% by weight of a low density polyethylene, and
(c) about 40% to about 60% by weight of calcium carbonate filler particles.

12. The film of claim 11 wherein the composition further contains high density polyethylene and titanium dioxide.

13. An incrementally stretched microembossed film having a high moisture vapor transmission rate (MVTR) comprising a thermoplastic polymer film containing a dispersed phase of particles selected from the group consisting of an inorganic filler and an organic material, said film having
(a) a microembossed rectangular pattern of about 250 embossed lines per inch, across the width of the film which intersect with embossed lines of about 250 lines per inch across the length of the film, said pattern having an embossed depth of about 0.001 to about 0.0015 inch,
(b) a film thickness of about 0.001 to about 0.002 inch with incrementally stretched areas in the film to provide microporosity in the film with an MVTR greater than about 1000 gms/m²/day according to ASTM E96E, and
(c) a film impact strength of greater than about 150 grams according to ASTM D1709.

14. The film of claim 13 wherein the thermoplastic composition is a polymer selected from the group consisting of polyethylene, polypropylene, and copolymers thereof.

15. The film of claim 13, wherein said thermoplastic composition is an elastomeric polymer.

16. The film of claim 13 wherein said elastomeric polymer is selected from the group consisting of poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), poly(ethylene butylacrylate), polyurethane, poly(ethylene-propylene-diene), and ethylene-propylene rubber.

17. The film of claim 13 wherein said inorganic filler is selected from the group consisting of calcium carbonate and barium sulfate.

18. The film of claim 13 having a portion thereof laminated to a strip or patch of a fibrous web.

19. The film of claim 18 wherein the fibers of said fibrous web are selected from the group consisting of polypropylene, polyethylene, polyesters, cellulose, rayon, nylon, and blends or co-extrusions of two or more of such fibers.

20. The film of claim 18 wherein the fibrous web has a weight from about 5 to about 70 gms/yd² and the microporous film has a thickness on the order of about 0.0008 to 0.002 inch.

21. The film of claim 13 wherein the film composition comprises
(a) about 30% to about 45% by weight of a linear low density polyethylene,
(b) about 1% to about 10% by weight of a low density polyethylene, and
(c) about 40% to about 60% by weight of calcium carbonate filler particles.

22. The film of claim 22 wherein the composition further contains high density polyethylene and titanium dioxide.

23. A high speed method of making a microembossed microporous thermoplastic film comprising
meltblending a thermoplastic polymer and filler particles to form a thermoplastic polymer composition,
extruding a web of said molten thermoplastic composition from a slot die through a cooling zone into a nip of rollers to form a film at a speed on the order of at least about 550 fpm to about 1200 fpm without draw resonance, said nip of rollers comprises a metal embossing roller having a rectangular engraving of intersecting CD and MD lines with about 165 to 300 lines/inch in each direction and a rubber roller and the compressive force between said rollers is controlled to form an embossed film,
applying an incremental stretching force to said film at said speeds along lines substantially uniformly across said film and throughout its depth to provide a microembossed microporous film.

24. The high speed method of claim 23 comprising introducing a strip of nonwoven fibrous web into said nip of rollers and controlling the compressive force between the strip and the film at the nip to bond the surface of the strip to only a portion of the film to form a laminated microporous sheet.

25. The high speed method of claim 24 wherein said fibrous web comprises polyolefin fibers.

26. The high speed method of claim 25 wherein said fibers are selected from the group consisting of polypropylene, polyethylene, polyesters, cellulose, rayon, nylon and blends or coextrusions of two or more such fibers.

27. The high speed method of claim 26 wherein the fibrous web has a weight of from about 5 to about 70 gms/yd² and the microporous film has a thickness on the order of about 0.001 to about 0.0015 inch.

28. The high speed method of claim 27 wherein said web is formed from staple fibers or filaments.

29. The high speed method of claim 23 wherein said web is formed from staple fibers or filaments.

30. The high speed method of claim 23 wherein said incremental stretching step is conducted at ambient temperature.

31. The high speed method of claim 23 wherein said film has a thickness on the order of about 0.0015 inch and an embossed depth of about 0.001 to about 0.0015 inch and said roller has about 250 lines per inch in each direction.

32. The high speed method of claim 23 wherein the fibrous web has a weight from about 5 to about 70 gms/yd² and the microporous film has a thickness on the order of about 0.0008 to 0.002 inch.
